(19) United States
(12) Patent Application Publication
(10) Pub. No.: US 2010/0026912 A1
(43) Pub. Date: Feb. 4, 2010

(54) Multifunction display system

(76) Inventor: Solomon Ho, Anaheim, CA (US)

Correspondence Address: LAW OFFICES OF CLEMENT CHENG, 17220 NEWHOPE STREET #127, FOUNTAIN VALLEY, CA, 92708, US

(21) Appl. No.: 12/221,163

(22) Filed: Jul. 31, 2008

(51) Int. Cl. H04N 5/64

(52) U.S. Cl. 348/836; 348/E05.128

(57) ABSTRACT

A multifunction display system is provided comprising a flat panel display screen; an electronic controller receiving video signal from an input and generating an output signal for displaying on the display screen; a power supply providing power to display screen and the electronic controller; a housing securing the display screen, the electronic controller and the power supply, wherein the housing includes a front shell and a rear shell that join together at a meeting line along a periphery of the display screen. The rear shell of the housing is a designed panel to receive multiple devices of specialized media playing capabilities in standardized boxes including but not limited to a regular or HD television tuner, a DVD and optical disc player, a digital video recorder, a hard drive player or an IPTV Divx player, mini PC and Internet and/or receiver router.

### BACKGROUND OF THE INVENTION

A. Field of the Invention

The present invention relates to a display system for playing audio and video content. More particularly, the present invention relates to an open display system with built-in bays for loading standardized media players to provide a centralized entertainment experience.

B. Description of the Prior Art

To introduce more realistic home theater entertainment experiences beyond the hi-fidelity quality, various efforts have been made in improving sound and picture quality by developing methods such as processing high definition video data. Along with such new formats of video processing come large LCD displays, which have become affordable to the general public as LCD panels are being manufactured at lower costs and at a faster rate. In step with new formats, movies and shows are produced with using compatible recording machines of cameras and microphones. This expanded the spectrum of available media players resulting in general movie viewers keeping multiple devices, which include mostly DVD players, game consoles, cable or satellite TV set-top boxes and more. It is well known that coming generations of HD TV calls for Blue-Ray DVD players and similar high grade of digital media players to connect with a state of the art flat screen display apparatus. With the advent of ample technologies to make more media devices more compact, smarter organizational methods have become more necessary. One application showing an organizational technique has been recognized in US patent application publication No. 2005/0200765 by inventor Sanchez. In the above publication, Sanchez discloses a modified picture frame and bracket adapted to mate with a flat TV to work as an extra bezel for the purpose of enhancing the plain front surface of the plastic edges of the TV. A separate electronic component receptacle is added to the frame trying to have an organized multimedia system. However, this add-on method all around a finished TV set will only add unnecessary bulkiness which unfortunately counters the benefit of having a wall mountable flat display. The publication fails to suggest an original solution to organizing the unsightly cables of multiple player modules.

Meanwhile, U.S. Pat. No. 7,046,310 to Lee describes a display apparatus and a placement of a tuner block removably screw fastened to a molded recess for the purpose of servicing the tuner circuit in case of malfunction before an easy replacement thereof. No suggestions can be found on how to place multiple media players in a slim manner in order to save space and even money by configuring a multifunction display system to suit the individual viewer's needs.

A variety of connections have also made the display sets more complicated and difficult to configure for the average home user wishing to set up a home theater system. For example, there are a variety of different types of sound and audio formats. Some formats include both audio and sound while some formats include only sound or audio. In combination with the above mentioned problem of having multiple formats, the home user has been inundated with a multiplicity of obscure cable connections and cable types.

Therefore, it is an object of the present invention to provide an improved display system having interchangeable player modules for slot loading on a display apparatus.

It is another object of the present invention to provide a display apparatus housing for holding the player modules at convenient areas of the display apparatus.

It is yet another object of the present invention to provide a display system having an integral docking bay with compatible template of connector set to eliminate the need to prepare and install separate cables and wiring components.

It is still another object of the present invention to provide a display system with integral mounting slots for different player modules that obviate the need for conventional media cabinet occupying substantial room for containing stacks of audio/video components.

### SUMMARY OF THE INVENTION

A multifunction display system of the present invention comprises: (a) a flat panel display screen, (b) an electronic controller receiving video signal from an input and generating an output signal for displaying on the display screen, (c) a power supply providing power to display screen and the electronic controller, (d) a housing securing the display screen, the electronic controller and the power supply, wherein the housing includes a front shell and a rear shell that join together at a meeting line along a periphery of the display screen, wherein the housing has a top side a bottom side, a left side and a right side, (e) a plurality of slots formed on the housing near the meeting line, wherein each of the plurality of slots has an outwardly facing surface within the slot, wherein each of the plurality of slots includes a video signal interface for the input located on the outwardly facing surface within the slot, and a standard power interface located on the outwardly facing surface within the slot, (f) a plurality of removable media players, each media player interchangeably fitting into each of the plurality of slots formed on the housing, wherein each of the plurality of removable media players has a depth that is approximately the same as a depth of the plurality of slots, and (g) a component docking station having both power and video interconnection between each of the plurality of removable media players and the electronic controller, wherein each of the plurality of removable media players has a media player output having an electrical connection to the input of the electronic controller at an interface formed on an inwardly facing surface of a removable media player and the outwardly facing surface of each of the plurality of slots, wherein each of the plurality of removable media players is powered by the standard power interface, whereby a user may exchange any one of the plurality of removable media players into any of the plurality of slots whereby a user may create a custom configuration.

The removable media players include one or combinations of the followings: a regular or HD television tuner, a DVD and optical disc player, a digital video recorder, a hard drive player or an IPTV Divx player, mini PC and Internet and/or receiver router. One of the plurality of slots is formed on the left side and one of the plurality of slots is formed on the right side. One of the plurality of slots is formed on the top side and one of the plurality of slots is formed on the right side. At least one of the plurality of slots is formed on the top side and one of the plurality of slots is formed on the left side. At least two of the plurality of slots are formed on the top side.

The multi-function display system comprises a main printed circuit board having an electronic controller and a remote control receiver receiving control signals from a remote control and transmitting control data to the electronic controller. In a completely wireless embodiment of the invention, the multifunction display system further comprises a remote control transmitter relay on the component docking station, wherein the electronic controller transmits control signals to the remote control transmitter relay, wherein the remote control transmitter relay transmits the control signal to a removable media player remote control receiver.

Embodiments of the invention will now be described by way of example with reference to the accompanying drawings.

### BRIEF DESCRIPTION OF THE DRAWINGS

FIG. 1 is a rear exploded perspective view of a multifunction display system according to the present invention.

FIG. 2 is a schematic view of the display system with a selection of available modular video playing modules according to one embodiment of the invention.

FIG. 3A is a rear view of a modular HDTV tuner box of the invention for loading in the integral docking station at the back of the display unit.

FIG. 3B is a front view of the HDTV tuner box.

FIG. 4A is a rear view of a Blue-Ray DVD/optical disc player box of the invention.

FIG. 4B is a front view of the Blue-Ray DVD/optical disc player box with a disc slot and control buttons.

FIG. 5A is a rear view of a digital video recorder box of the invention.

FIG. 5B is a front view of the digital video recorder box with a disc tray and control buttons.

FIG. 6A is a rear view of a hard drive player and IPTV Divx player box of the invention.

FIG. 6B is a front view of the hard drive player box with a memory cards slot and input jacks.

FIG. 7 is a rear exploded perspective view similar to FIG. 1 with a mini PC box is ready to dock in a designated bay to transform the display system into an all-in-one computer with an addition of input peripherals.

FIG. 8A is a rear view of the mini PC box for connecting to the display system of the invention.

FIG. 8B is a front view of the mini PC box providing a disc tray, various connection jacks and control buttons.

Similar reference numbers denote corresponding features throughout the attached drawings.

### DETAILED DESCRIPTION OF THE PREFERRED EMBODIMENT

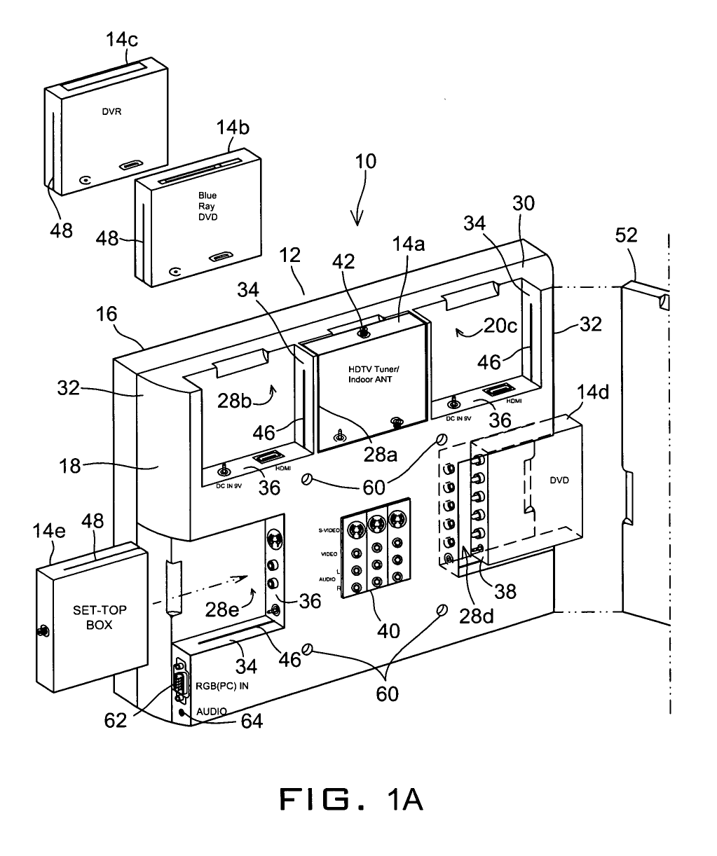

With reference to FIG. 1, a multifunction display system 10 according to the present invention is based on a main unit 12 of a flat panel display set that receives audio and video signals from one of conventional media players including a high-definition multimedia interface. Main unit 12 may be a small portable displaying apparatus or a big pedestal screen monitor for family viewing of movies in a large room. The main unit 12 is preferably optimized to show digital contents but may be backward compatible to receive analogue audio/video signals from traditional media players like a VHS tape players and non-HD DVD players. According to the present invention, connection ports of popular RGB, S-video connectors, and digital connections such as HDMI, USB, VGA, Ethernet, and such are grouped in the back as well as along periphery of main unit 12 to mate directly with standardized play boxes 14a to 14e respectively containing different conventional player functions and connection ports.

The respective play boxes may encase a CD/DVD player including newly introduced blue-ray or HD DVD, CD/DVD recorder compatible with the said CD/DVD player, analogue or digital TV tuner, DVR (TiVo®), IPTV digital media gateway or Divx player, TV games, universal memory reader, rechargeable battery, satellite receiver device, home theater system and other units.

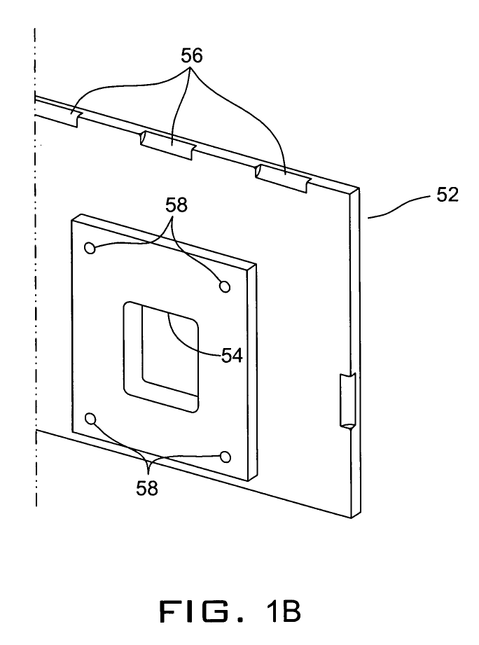

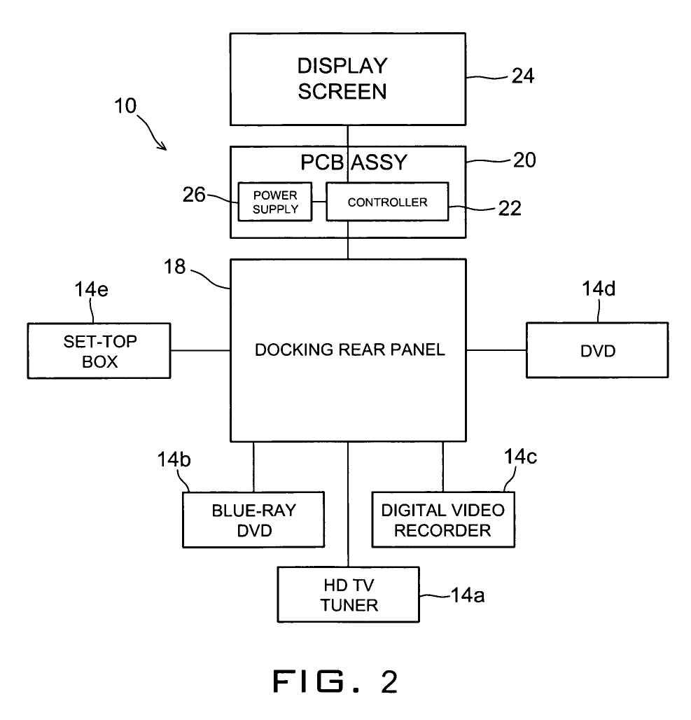

In main unit 12, there are installed a conventional display screen framed by a rectangular front case 16 leaving a picture viewing area and facing away from rear panel 18 attached to front case 16, a printed circuit board assembly 20 (shown schematically in FIG. 2) supported behind the display screen for generating and supplying to the display screen a picture signal from a designated source of the above player box modules. The circuit board 20 receives and can process RGB analog outputs of a personal computer to make an appropriate digital conversion for viewing on the display system 10 that serves as a computer monitor. Display system 10 may also include audio speakers to constitute a multimedia hub for accepting a number of existing and future player units in an easy form factor to make, handle, connect and store.

As shown in FIG. 2, circuit board 20 of display system 10 includes an electronic controller 22 for receiving audio/video data from sources of play boxes 14a-14e at an input and generating an output signal for display on the display screen at 24. In addition, display system 10 has a power supply 26 for powering display screen 24 and the electronic controller 22.

Resembling a uniform construction block system, rear panel 18 has multiple bay areas 28a to 28e formed at convenient positions along topside 30 and two lateral sides 32 of main unit 12 to accommodate play boxes 14a-14e, respectively. Each bay is made of a deep recess opening radially outwardly of the center of main unit 12 so that slot boxes 14a-14e can easily slide in the designated bay 28a-28e at the rear of the main unit 12. Each of the player bays 28a-28e forms a loading slot 34 and an outwardly facing end surface 36 within the slot 34, wherein each of the plurality of surfaces 36 includes a specified connection interface for the corresponding player box 14a-14e having its own connection port facing end surface 36.

Specifically, set-top box 14e may be designated to dock laterally into bay 20e, which has an S-video input, L and R stereo audio inputs and a 9V power jack as identified in the drawing and adapted to accept the corresponding output connectors and a power plug (DC 9V) on set-top box 14e. At opposite side of bay 20e is bay 20d for accepting DVD box 14d shown in a loading position. Bay 20d may have a connection port 38 for supplying component video output, L and R stereo audio outputs and a power plug. At the side of bay 28d, matching input connectors and a power plug are aligned with connectors and the power plug of port 38.

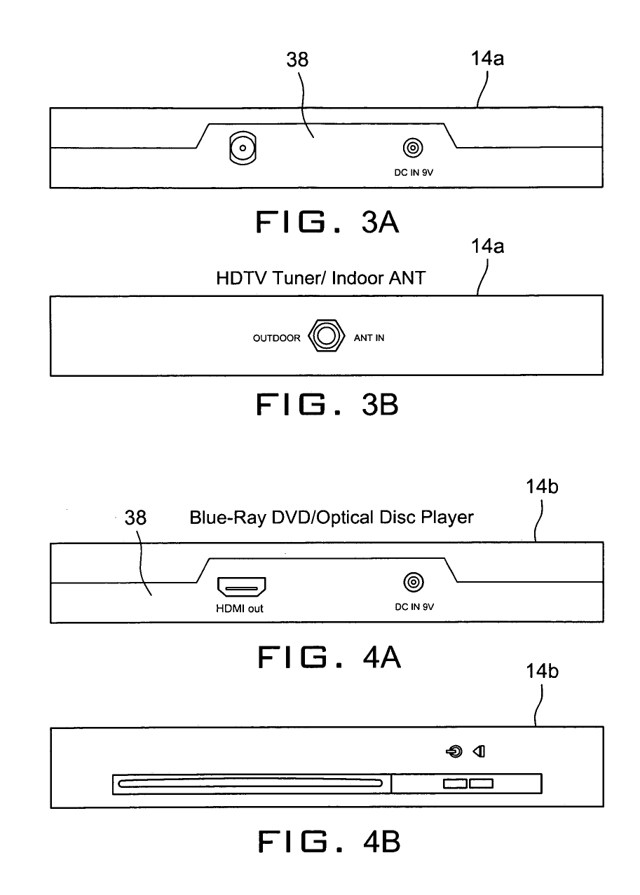

Between the lateral bays 14d and 14e, an extra port 40 may comprise multiple sets of audio/video connectors. In each connector set, an S-video, a regular video and stereo L and R audio jacks are grouped although different combinations are readily available according to a particular design of display system 10. Main unit 12 has a distributed connection port system, which comprises backward port 40 in the center about which radially facing multiple connector sets are positioned to couple with respectively functional player boxes mechanically as well as electrically. Of the top row bays, center bay 28a may be designated to accept HDTV tuner box 14a shown in placement already and has a male or female tuner connector protruding in its bottom surface to a mating connector on bay 28a. On top edge of tuner box 14a, an antenna jack 42 may be positioned to accept an outdoor antenna line to boost signal power although tuner box 14a itself may contain an indoor antenna. See FIGS. 3A and 3B for bottom and top views of box 14a, respectively. In this case, bay 28a also provides a dedicated DC power outlet to operate the antenna circuit.

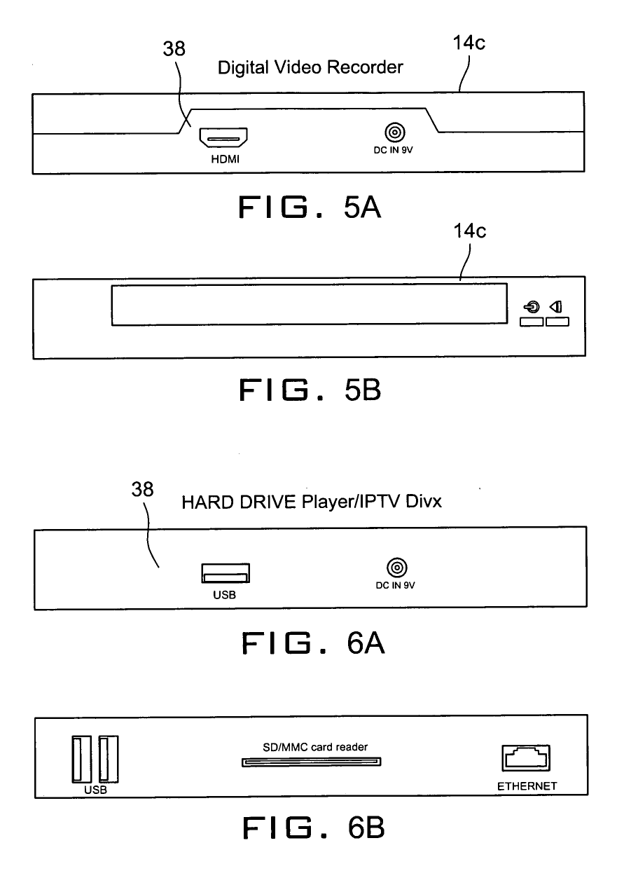

Preparing for insertion to bays 28b and 28c, Blue-Ray DVD box 14b is shown in more detail in FIGS. 4A and 4B and digital video recorder box 14c is detailed in FIGS. 5A and 5B.

On end surfaces 36 of both side bays 28b and 28c of tuner bay 28a High-Definition Multimedia Interface (HDMI) plug may be placed at one side and a DC power output plug is placed at the other side preferably at equal distances from the middle considering the balanced thrust of player box connectors into the mating connectors of the respective bays 28b, 28c.

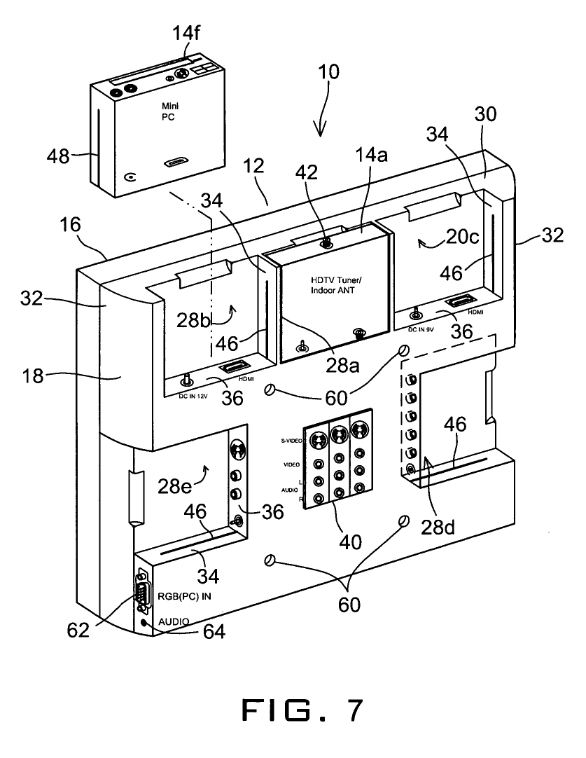

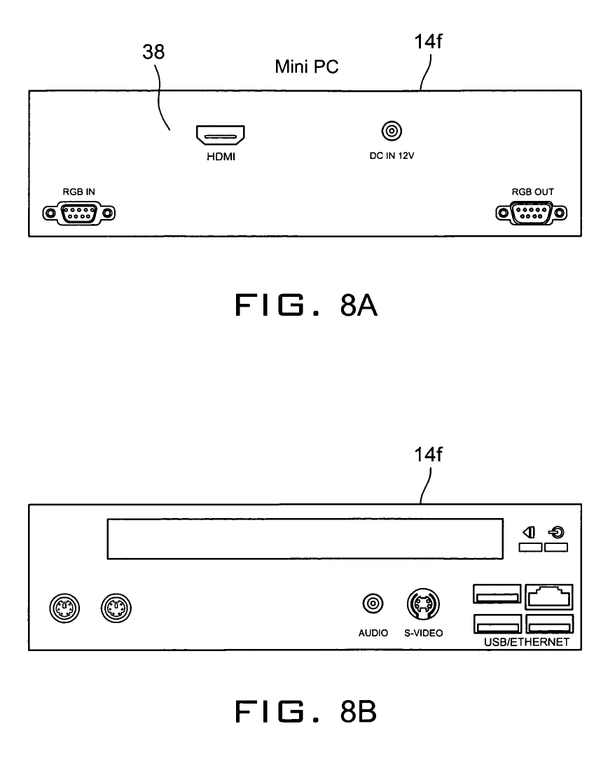

As convenience features for loading player boxes into bays, there are guide rails 46 formed on bays 28a-28e and extending in the direction of loading boxes 14e, which have cooperating side slots 48 for engaging guide rails 46 to keep the player boxes and thus their connectors aligned with respective to the corresponding plug and jacks on end surfaces 36. Snug engagements between guide rails 46 and box slots 48 secure player boxes 14a-14e against inadvertent detachment from main unit 12. Partial chamfers 50 formed at the entrance of each bay facilitate gripping player boxes to retrieve them for the purpose servicing faulty boxes or swapping with newer devices as will be described with reference to FIG. 7.

In addition, an optional back plate 52 may be provided to cover rear panel 18 leaving a raised rectangular aperture 54 to reveal extra port 40 in the center. Although omitted from the drawings, ventilation slots and openings are important parts of the cabinetry of main unit 12 to keep down the internal operational heat and prevent dust from building up. Back plate 52 may have rectangular sides that evenly cover rear panel 18 and the loaded player boxes for the sake of a visually clean backside but maintain a clearance from panel 18 around its peripheral edges to provide the ventilation of heat from every player boxes in operation. Back plate 52 also has partial chamfers 56 at opposite locations of chamfers 50 of rear panel 18 to ease the access to docked player boxes. To mount display system 10 onto wall through a wall-mount bracket, back plate 52 may accept hooks (not shown) protruding backwards through bores 58 where the hooks may be driven to penetrate main unit 12 at screw holes 60 that are appropriately reinforced with buried bolts. The hooks are then securely fixed to the bracket on the wall.

With main unit 12 alone, it only costs comparably to more economical computer monitor for a user who may connect an existing personal computer to an RGB (PC) IN connector 62 and/or an audio jack 64 at a convenient lower side edge of unit 12. Due to hidden bays 28a-28e blended well into the casing of main unit 12, display system 10 functions perfectly as an aesthetic monitor the user may then connect existing audio/video sources conventionally to center port 40. As needs arise, the user can anytime exercise the option to add more compatible player boxes 14a-14e to main unit 12 at appropriate bays. Due to the integral bay configuration of the present invention, display system 10 is freely mounted on a horizontal tabletop or a vertical wall without interfering the respective media play functions in the ultimate compact form of the present invention.

FIGS. 6A and 6B depict the rear and front ports of a hard drive/IPTV Divx player enclosed by a similar box to player boxes 14a-14e. IPTV digital media gateway or Divx player is a set-top box for delivering broadband downloads of video and audio contents. The player is connected to user's local network using a standard Ethernet or wireless connection allowing access and broadcast content from any computer on the network as well as any attached USB drive.

FIG. 7 shows a typical mini PC in a docking box 14f that is equipped with a rear connection port adapted to connect with bay 28b with the connection port on its end surface 36. Outside of bay 28b Mini PC 14f is a portable computer that can be used with any compatible peripheral devices for various business tasks. Inside display system 10, mini PC 14f transforms into an all-in-one big computer, which can share the screen with other player modules like the high definition visual source of tuner box 14a. The mini PC docked may have a Wi-Fi receiver for connection to Internet wirelessly with the assistance of a Wi-Fi router/receiver in a player box (not shown) docked in a separately assigned bay.

Besides the stated player functions, many future or near future player boxes will be available to work within display system 10: for example, various players with a dock for I-POD-brand devices may be reconfigured to fit in the player box of the present invention so that a dock-in-dock system can be created based on display system 10. Or, such Wi-Fi enabled hand-held devices may take advantage of the Wi-Fi receiver box remotely and play their contents through the big screen of display system 10.

It is understood that a skilled in the art can modify an existing remote control to remotely operate every one of the player boxes as described above. Specifically, the multifunction display system 10 may further comprise a remote control transmitter relay on each docking bay, wherein the electronic controller transmits control signals to the remote control transmitter relay, wherein the remote control transmitter relay transmits the control signal to a remote control receiver on the media player box.

Throughout the opposing connector alignments described, either male plugs or female jacks may be mounted on a bay or player box. For example, player boxes may have jacks to provide less protruding surfaces for the safe handling of individual player boxes from manufacturing through final placement in the main unit 12. Or they may have plugs instead for easier controlled insertion into the stationary ports of fixed main unit 12.

By eliminating conventional extra wires and couplings to display system 10, possibilities of signal degradations are no more according to the present invention. Moreover, keeping display system 10 function simple by leaving out any signal sources including a tuner but instead providing a full scale bay panel 18 formed integral to display system 10 enables a new paradigm of electronic entertainment delivery to viewers.

The best mode for implementing the invention is to have a connection such as HDMI on the end surface 36 operate as a universal connection which provides connection to DVD as well as tuner. Therefore, the connections shown in FIG. 1A can all be used independently, however it is best to have all connections be the same for each bay, the HDMI connector can be used for all of them such that all of the bays in FIG. 1A are HDMI or all of the connectors are component video and audio, or all of the connectors are of some other special proprietary type of connector. Having all of the connectors be the same provides modular interchangeability.

Therefore, while the presently preferred form of the multifunction display system has been shown and described, and several modifications thereof discussed, persons skilled in this art will readily appreciate that various additional changes and modifications may be made without departing from the spirit of the invention, as defined and differentiated by the following claims.

1. A multifunction display system comprising:
a. a flat panel display screen;
b. an electronic controller receiving video signal from an input and generating an output signal for displaying on the display screen;
c. a power supply providing power to display screen and the electronic controller;
d. a housing securing the display screen, the electronic controller and the power supply, wherein the housing includes a front shell and a rear shell that join together at a meeting line along a periphery of the display screen, wherein the housing has a top side a bottom side, a left side and a right side;
e. a plurality of slots formed on the housing near the meeting line, wherein each of the plurality of slots has an outwardly facing surface within the slot, wherein each of the plurality of slots includes a video signal interface for the input located on the outwardly facing surface within the slot, and a standard power interface located on the outwardly facing surface within the slot;
f. a plurality of removable media players, each media player interchangeably fitting into each of the plurality of slots formed on the housing, wherein each of the plurality of removable media players has a depth that is approximately the same as a depth of the plurality of slots; and
g. a component docking station having both power and video interconnection between each of the plurality of removable media players and the electronic controller, wherein each of the plurality of removable media players has a media player output having an electrical connection to the input of the electronic controller at an interface formed on an inwardly facing surface of a removable media player and the outwardly facing surface of each of the plurality of slots, wherein each of the plurality of removable media players is powered by the standard power interface, whereby a user may exchange any one of the plurality of removable media players into any of the plurality of slots whereby a user may create a custom configuration.

2. The multi-function display system of claim 1, wherein at least one of the plurality of removable media players includes a television tuner.

3. The multi-function display system of claim 1, wherein at least one of the plurality of removable media players includes an optical disc player.

4. The multi-function display system of claim 1, wherein at least one of the plurality of removable media players includes digital video recorder.

5. The multi-function display system of claim 1, wherein at least one of the plurality of removable media players includes a hard drive player.

6. The multi-function display system of claim 1, wherein at least one of the plurality of removable media players includes an IPTV Divx player.

7. The multi-function display system of claim 1, wherein at least one of the plurality of removable media players includes a mini PC.

8. The multi-function display system of claim 1, wherein at least one of the plurality of removable media players includes Internet and/or receiver router.

9. The multi-function display system of claim 1, wherein at least one of the plurality of slots is formed on the left side and one of the plurality of slots is formed on the right side.

10. The multi-function display system of claim 1, wherein at least one of the plurality of slots is formed on the top side and one of the plurality of slots is formed on the right side.

11. The multi-function display system of claim 1, wherein at least one of the plurality of slots is formed on the top side and one of the plurality of slots is formed on the left side.

12. The multi-function display system of claim 1, wherein at least two of the plurality of slots are formed on the top side.

13. The multi-function display system of claim 1, further comprising a main remote control receiver receiving control signals from a remote control and transmitting control data to the electronic controller, further comprising a remote control transmitter relay on the component docking station, wherein the electronic controller transmits control signals to the remote control transmitter relay, wherein the remote control transmitter relay transmits the control signal to a removable media player remote control receiver.

14. The multi-function display system of claim 13, wherein at least one of the plurality of removable media players includes a television tuner.

15. The multi-function display system of claim 13, wherein at least one of the plurality of removable media players includes an optical disc player.

16. A multifunction display system comprising:
a. a flat panel display screen;
b. an electronic controller receiving video signals from an input and generating an output signal for display on the display screen;
c. a power supply providing power to the display screen and the electronic controller;
d. a housing securing the display screen, the electronic controller and the power supply, wherein the housing includes a front shell and a rear shell that join together at a meeting line along a periphery of the display screen, wherein the housing has a top side, a bottom side, a left side and a right side;
e. a plurality of slots formed on the housing near the meeting line, wherein each of the plurality of slots has an outwardly facing surface within the slot, wherein each of the plurality of slots includes a video signal interface for the input located on the outwardly facing surface within the slot, and a standard power interface located on the outwardly facing surface within the slot;
f. a plurality of removable media players, each media player interchangeably fitting into each of the plurality of slots formed on the housing, wherein each of the plurality of removable media players has a depth that is approximately the same as a depth of the plurality of slots,
g. a component docking station; the component docking station having both power and video interconnection between each of the plurality of removable media players and the electronic controller, wherein each of the plurality of removable media players has a media player output having an electrical connection to the input of the electronic controller at an interface formed on an inwardly facing surface of a removable media player and the outwardly facing surface of each of the plurality of slots, wherein each of the plurality of removable media players is powered by the standard power interface, whereby a user may exchange any one of the plurality of removable media players into any of the plurality of slots whereby a user may create a custom configuration.

17. The multi-function display system of claim 16, further comprising a main remote control receiver receiving control signals from a remote control and transmitting control data to the electronic controller, further comprising a remote control transmitter relay on the component docking station, wherein the electronic controller transmits control signals to the remote control transmitter relay, wherein the remote control transmitter relay transmits the control signal to a removable media player remote control receiver.
